(19) United States
(12) Patent Application Publication
(10) Pub. No.: US 2026/0308895 A1
(43) Pub. Date: Oct. 8, 2026

(54) Touchless Faucet with Integrated Flosser

(71) Applicant: Tony Selimi, Cape Coral, FL (US)

(72) Inventor: Tony Selimi, Cape Coral, FL (US)

(21) Appl. No.: 19/704,981

(22) Filed: Jun. 11, 2026

Related U.S. Application Data
(63) Continuation-in-part of application No. 19/640,301, filed on Apr. 6, 2026.
(60) Provisional application No. 63/783,773, filed on Apr. 4, 2025.

(51) Int. Cl. E03C 1/048; A61C 17/032; E03C 1/02; E03C 1/05; G05D 11/16

(52) U.S. Cl. CPC E03C 1/048; A61C 17/032; E03C 1/023; E03C 1/057; G05D 11/16

(57) ABSTRACT

A touchless faucet and flosser system includes a faucet assembly, a removably coupled flosser assembly, a water supply system, and an electronic control system. The faucet assembly includes a faucet body having a flosser recess configured to receive the flosser assembly. The water supply system receives water from an external water source and selectively directs the water to either a faucet outlet or a flosser outlet. The electronic control system is operably coupled to motion sensors, electronically controlled valves, a water pump, a pressure sensor, and a temperature sensor to regulate water flow, pressure, and temperature. A user interface may include motion sensors, a display, and a toggle switch for selecting faucet or flosser operation. The system may be mounted with a sink basin and housed at least partially within a sink base cabinet.

The current application claims a priority to the U.S. provisional patent application Ser. No. 63/783,773 filed on Apr. 4, 2025.

### FIELD OF THE INVENTION

The present invention generally relates to a sink. More specifically, the present invention is a touchless faucet with a retractable water flosser integrated into the faucet.

### BACKGROUND OF THE INVENTION

Touchless faucets have become increasingly common in both residential and commercial settings due to their hygienic advantages, water conservation benefits, and ease of use. These faucets typically operate via motion sensors, allowing water to flow automatically when a user's hands are detected beneath the spout. While this technology has advanced in recent years to include temperature and flow rate controls via gestures or touch-sensitive interfaces, it remains primarily limited to basic hand-washing functionality.

Similarly, water flossers, also known as oral irrigators, have emerged as an effective tool in personal dental hygiene. These devices employ a focused stream of pressurized water to dislodge food particles and plaque from between the teeth and below the gumline. Numerous clinical studies have validated their ability to reduce gingivitis and promote gum health when used in conjunction with, or as an alternative to, traditional string flossing. Water flossers typically exist as stand-alone countertop devices, requiring a separate reservoir, power source, and physical space on a sink or bathroom counter.

Despite the widespread adoption of both touchless faucets and water flossers, each system operates independently and with substantial redundancy in infrastructure. Most water flossers include an internal water pump, separate tubing, and proprietary water containers—components that replicate functionality already present in modern plumbing fixtures. This duplication not only increases the cost and complexity of ownership but also contributes to countertop clutter, inconvenience, and the potential for reduced user compliance with daily flossing routines. Users are required to manage two devices with overlapping functions, navigate multiple controls, and dedicate additional time and effort to oral care.

Furthermore, conventional water flossers typically lack the smart control and gesture-based inputs found in modern faucet systems. Likewise, most touchless faucets do not integrate any form of multi-functionality beyond handwashing. Thus, the current landscape of faucet and oral hygiene technology presents a fragmented and inefficient user experience, particularly in smaller or shared living spaces.

In light of these limitations, there exists a need for an integrated solution that combines the hygienic benefits and convenience of a touchless faucet with the therapeutic functionality of a water flosser. Such a system should reduce redundancy, save space, streamline user interaction, and improve overall compliance with daily hygiene routines.

Accordingly, an objective of the present invention is to provide a touchless faucet system with an integrated flosser that consolidates water control, oral hygiene functionality, and user interface into a single, cohesive unit. The present invention seeks to eliminate the need for a separate countertop flosser while leveraging the same water supply and electronic control infrastructure already present in advanced faucet systems.

Another objective of the present invention is to enable intuitive control of both faucet and flosser functions through motion sensors, display screens, and toggle switches, thereby enhancing ease of use and minimizing physical contact with the device—an especially important feature in medical, hospitality, and food preparation environments where hygiene is critical.

A further objective is to provide precise control over water temperature and pressure for both the faucet and flosser through a responsive electronic control system. By integrating temperature and pressure sensors, electronic ball valves, and a smart controller, the system ensures a consistent and customizable user experience across both functions.

Additionally, the present invention aims to reduce clutter and improve the aesthetic appeal of bathroom or kitchen spaces by housing the flosser within a recess of the faucet body, and by routing water through internal conduits shared with the faucet system. The invention offers a sleek, efficient, and sanitary solution that elevates personal hygiene while simplifying the overall design of sink areas.

### BRIEF DESCRIPTION OF THE DRAWINGS

FIG. 1 is a perspective view of the present invention.

FIG. 2 is a detailed perspective view of the present invention.

FIG. 3 is an alternate perspective view of the present invention.

FIG. 4 is a diagram of the faucet assembly and flosser assembly of the present invention.

FIG. 5 is a diagram if the faucet assembly and the at least one motion sensor thereof.

FIG. 6 is a detailed view of the faucet assembly and flosser assembly of the present invention.

FIG. 7 is a rear perspective view of the present invention showing the electrical control system and the water supply system thereof.

FIG. 8 is a detailed view of the electrical control system of the present invention.

FIG. 9 is an electrical diagram of the present invention.

FIG. 10 is a front view of the present invention.

FIG. 11 is a profile view of the present invention.

### DETAILED DESCRIPTION OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and is made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denote “at least one” but do not exclude a plurality unless the contextual use dictates otherwise. When used herein to join a list of items, “or” denotes “at least one of the items” but does not exclude a plurality of items of the list. Finally, when used herein to join a list of items, “and” denotes “all of the items of the list”.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification, and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate.

The present disclosure includes many aspects and features. Moreover, while many aspects and features relate to, and are described in the context of a touchless faucet with integrated flosser 1, embodiments of the present disclosure are not limited to use only in this context.

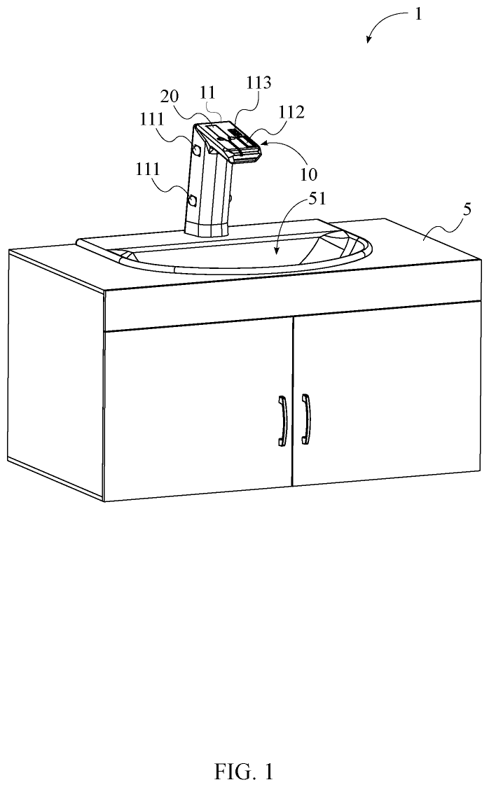

As shown in FIGS. 1-11, the present invention is a touchless faucet with integrated flosser 1 comprising a faucet assembly 10, a flosser assembly 20, a water supply system 30, and an electronic control system 40. In the preferred embodiment of the present invention, flosser assembly 20 is removably coupled to the faucet assembly 10. Furthermore, in the context of the present invention, the water supply system 30 communicates water from an external water source, through the faucet assembly 10 and the flosser assembly 20, wherein the water is expelled from the system. In the context of the present invention, the aforementioned “the system” and as mentioned herein, is intended to specify the claimed bounds of the present invention, such that the system (i.e. the present invention), receives water from an external system, and expels said water from said system. Additionally, in the context of the present invention, the electronic control system 40 converts electronic signals to physical transformations (i.e. an electronic valve), thus facilitating communication of water through the water supply system 30, flosser assembly 20, and faucet assembly 10.

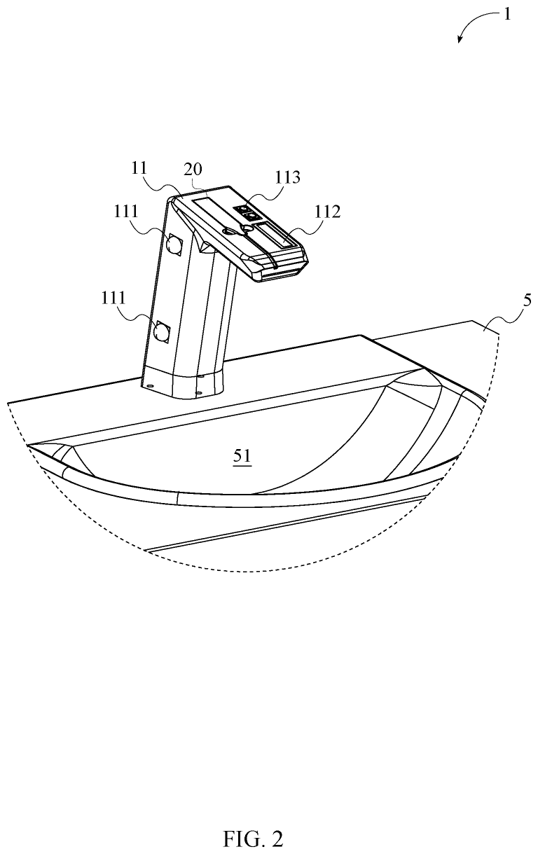

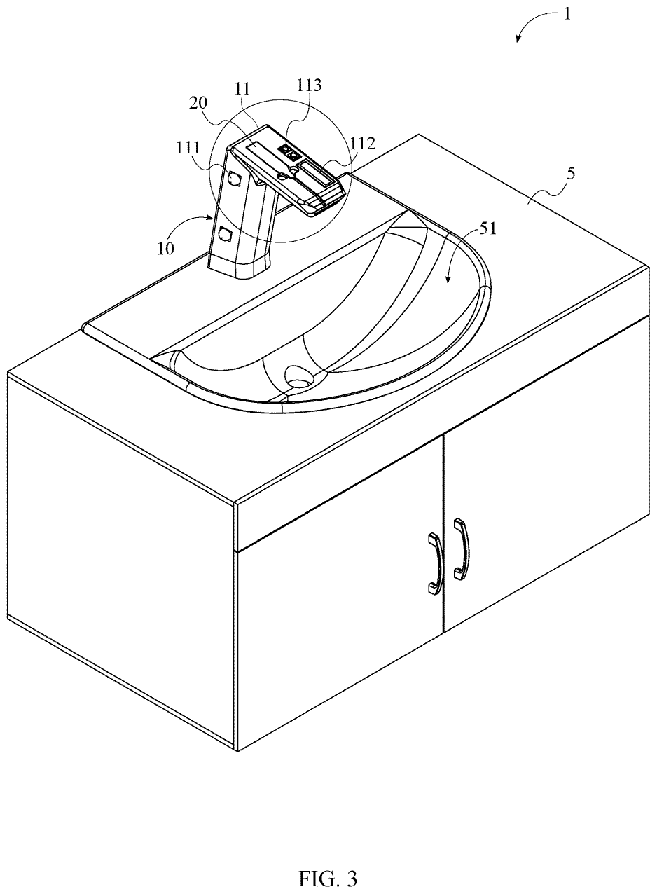

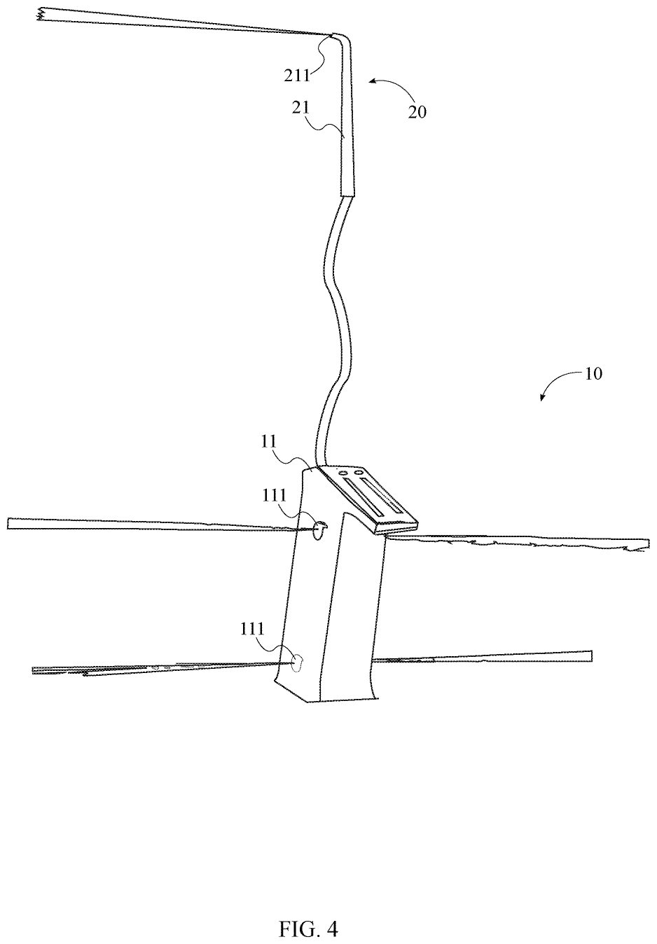

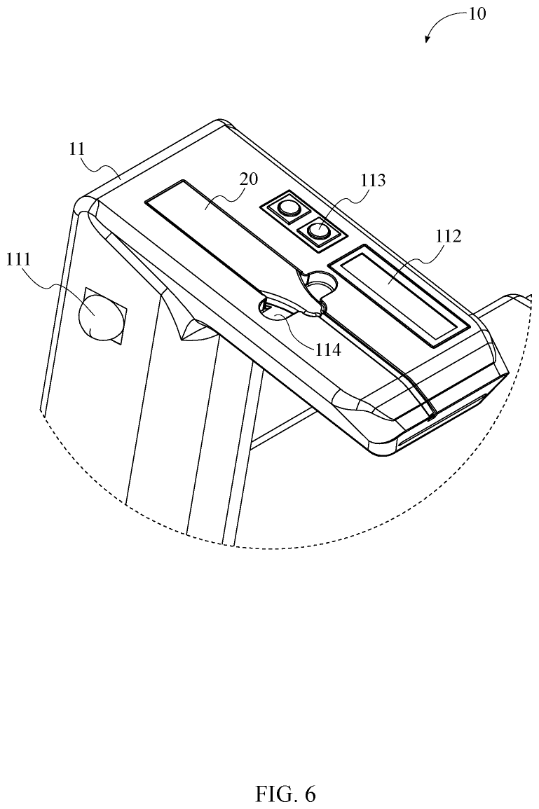

In the preferred embodiment of the present invention, as shown in FIGS. 2 and 3, the faucet assembly 10 comprises a faucet body 11 wherein said faucet body 11 comprises a flosser recess 114 (FIG. 6) wherein said flosser recess 114 is a cavity wherein the flosser assembly 20 is removably coupled. Furthermore, in the preferred embodiment of the present invention, the faucet body 11 further comprises a user interface wherein said user interface comprises an at least one motion sensor 111, a display 112, and a toggle switch 113. In the context of the present invention, the toggle switch 113 enables a user to selectively alter the system from expelling water through the faucet assembly 10 or expelling water through the flosser assembly 20. In the preferred embodiment of the present invention, the flosser assembly 20 comprises a flosser body 21 and an outlet 211 wherein the outlet 211expels water from the flosser body 21. In the context of the present invention, the flosser assembly 20 is a device that uses a stream of pressurized water to clean between the teeth of a user, as shown in FIG. 4.

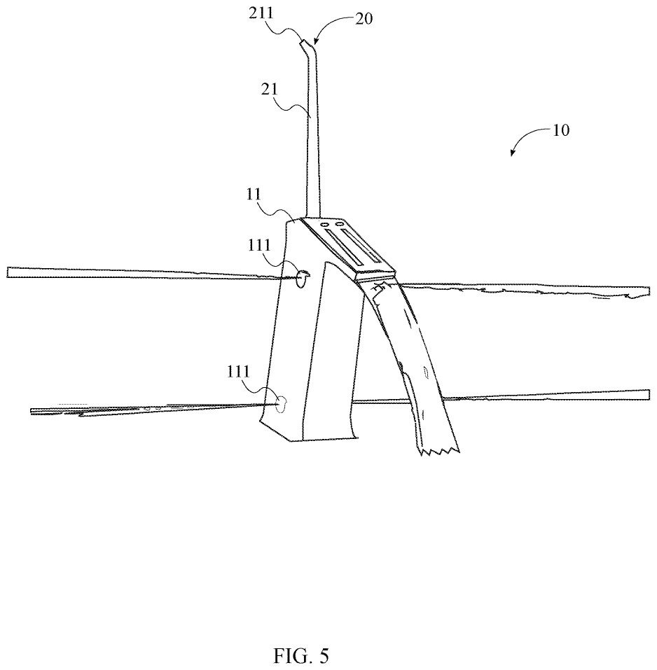

As shown in FIG. 5, in the context of the present invention, the at least one motion sensor 111 comprises a plurality of motion sensors 111 wherein said plurality of motion sensors 111 comprises a first motion sensor 111 wherein said first motion sensor 111 enables the flow of water from the faucet assembly 10. Additionally, in the preferred embodiment of the present invention, the plurality of motion sensors 111 comprises a first pair of motion sensors 111 and a second pair of motion sensors 111 wherein said first and second pairs of motion sensors 111 are configured facing outwardly on opposing lateral sides of the faucet. In some embodiments of the present invention, the first pair of motion sensors 111 would receive user input and facilitate user manipulation of temperature control. For example, in the aforementioned embodiment, variations in a user's hand position (i.e. raising and lowering of a user's hand) would generate an input, such that said inputs would be received by the first pair of motion sensors 111 and transmit a signal to the electronic control system 40, thus varying the temperature of the water expelled from the faucet assembly 10. Likewise, in some embodiments of the present invention, the second pair of motion sensors 111 would receive user input and facilitate user manipulation of pressure control. For example, in the aforementioned embodiment, variations in a user's hand position (i.e. raising and lowering of a user's hand) would generate an input, such that said inputs would be received by the second pair of motion sensors 111 and transmit a signal to the electronic control system 40, thus varying the pressure of the water expelled from the faucet assembly 10.

In the preferred embodiment of the present invention, as shown in FIG. 6, the display 112 is a screen that generates visual outputs to the user. In the preferred embodiment of the present invention, the display 112 is positioned on a topmost facing surface of the faucet body 11. Additionally, in some embodiments of the present invention, the display 112 is a touch screen wherein said display 112 receives user input.

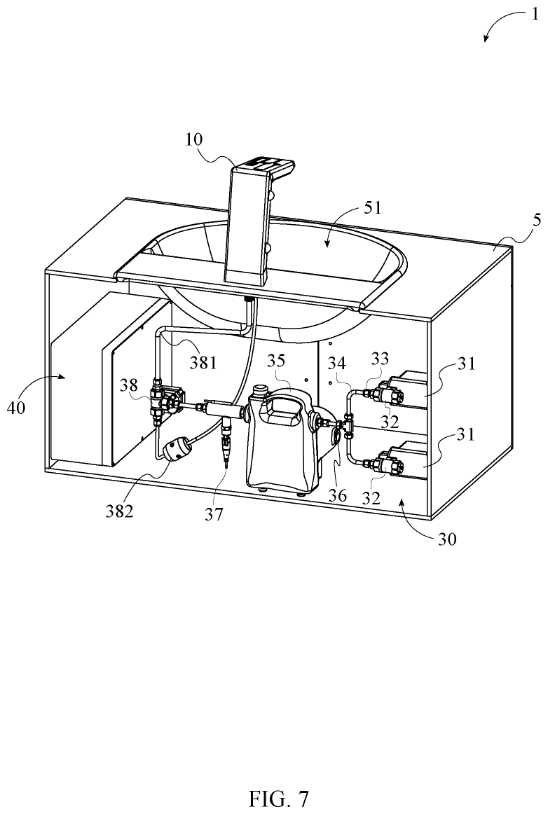

In the preferred embodiment of the present invention, as shown in FIG. 7, the water supply system 30 comprises a hot-water intake 31, a cold-water intake 31, a water pump 35, a pressure sensor 36, and a temperature sensor 37. In the context of the present invention, the hot water intake 31 and the cold-water intake 31 are coupling by which hot water and cold water respectively, enter the system from an external water source. Additionally, in the context of the present invention, the water pump 35 drives water through the water supply system 30 from the hot and cold-water intakes 31 until it is expelled. Further, the temperature sensor 37 and the pressure sensor 36 measure the respective variables and communicate signals to the electronic control system 40, indicative of said respective variables.

In the preferred embodiment of the present invention, water enters into the system through the hot and cold-water intakes 31, wherein said water is communicated through an electronically controlled ball valves 32, such that said ball valves 32 vary the ratio of hot and cold water entering the system. In the preferred embodiment of the present invention, the ball valves 32 are controlled through the electronic control system 40, such that user input signals received by the at least one motion sensor 111 are transmitted and converted into electrical signals which manipulate the ball valves 32. Upon entering the system, the hot and cold water is communicated through converging conduits, thus mixing the hot and cold water. Once mixed, the water is communicated through the water pump 35 wherein the temperature and pressure sensors 36,37 measure the temperature and pressure of the water, respectively. The water is then diverted to either the faucet assembly 10 or the flosser assembly 20, through a section of conduit 381, wherein the diversion of water is facilitated by a second electronic ball valve 32 actuated by the toggle switch 113. In the preferred embodiment of the present invention, the section of conduit 381 diverting the water to the flosser assembly 20, extends through the faucet body 11. Additionally, in the preferred embodiment of the present invention, the conduit 381 diverting the water to the flosser assembly 20 comprises a weight 382, such that said weight maintains a tensive force on said conduit 381.

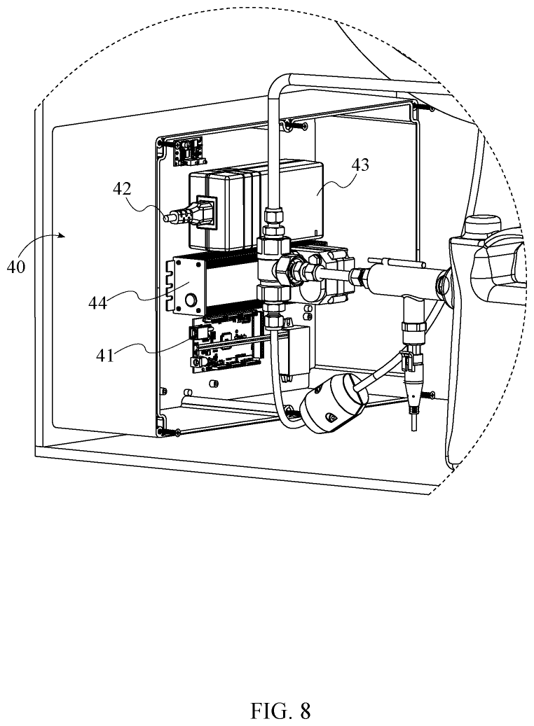

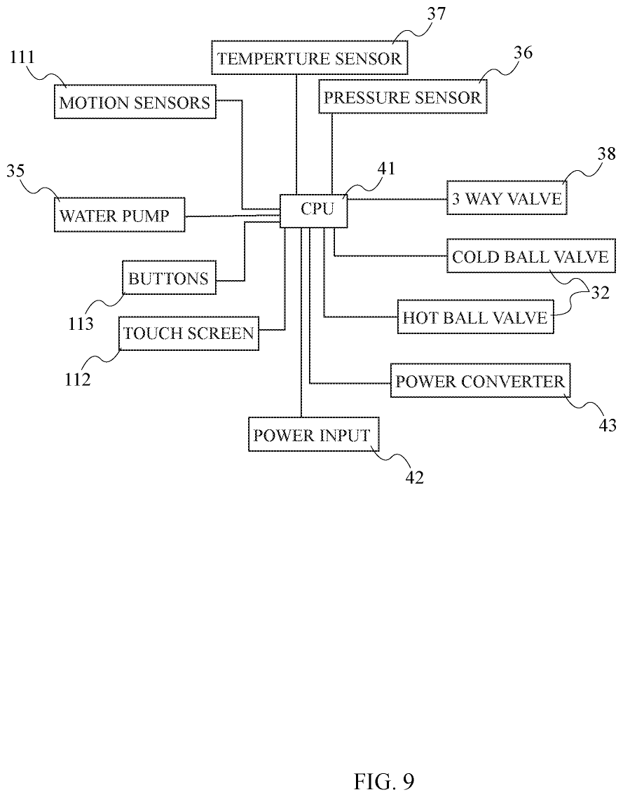

Furthermore, as shown in FIGS. 7 and 8, in the preferred embodiment of the present invention, the electronic control system 40 comprises a main controller 41 wherein said main controller 41 executes computer readable methods. Furthermore, in the preferred embodiment of the present invention, the electronic control system 40 further comprises a power input 42, a power converter 43, and a control generator 44. As shown in FIG. 9 in the preferred embodiment, the main controller 41 transmits signals, receives signals, and executes computer readable methods to facilitate the operation of the temperature sensor 37, the pressure sensor 36, the electronically controlled ball valves 32, the power converter 43, the power input 42, the user interface 112, and the water pump 35. In the preferred embodiment of the present invention, the power input 42 is a 24 V power supply. Additionally, in the preferred embodiment of the present invention, the control generator is a 4-20 mA control generator.

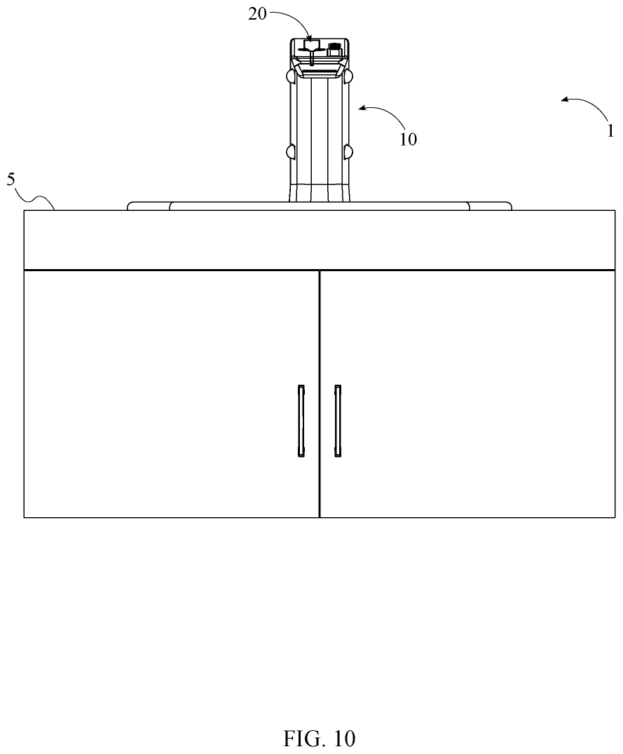

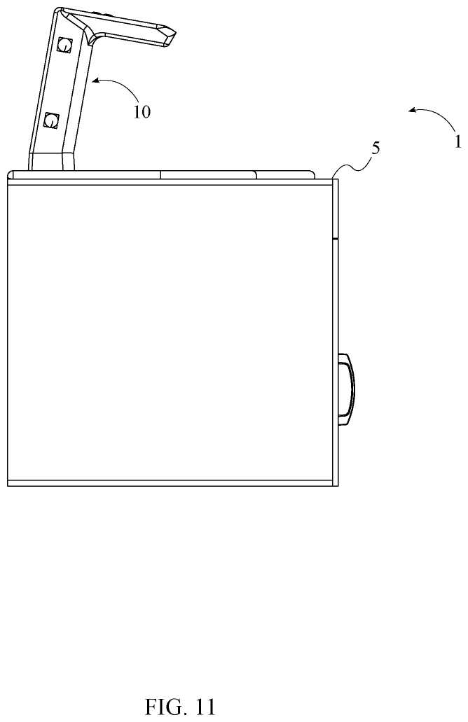

Furthermore, within the preferred embodiment of the present invention, as shown in FIGS. 10 and 11, the present invention is contained within a sink base cabinet 5 or structure of the like wherein the electrical control system and the water supply system 30 are contained within the sink base cabinet 5. Furthermore, within the preferred embodiment of the present invention, sink base cabinet 5 further comprises a basin 51 (i.e. a sink bowl), wherein the water expelled from the faucet assembly 10 and the flosser assembly 20 may be expelled into said basin 51.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

Although the invention has been explained in relation to its preferred embodiment, it is to be understood that many other possible modifications and variations can be made without departing from the spirit and scope of the invention.

What is claimed is:

1. A touchless faucet and flosser system comprising:
a faucet assembly comprising a faucet body, a faucet outlet, and a flosser recess wherein said flosser recess is formed into the faucet body;
a flosser assembly removably received within the flosser recess;
the flosser assembly comprising a flosser body and a flosser outlet wherein said flosser outlet is configured to expel pressurized water;
a water supply system configured to receive water from an external water source and selectively communicate the water to at least one of: the faucet outlet and the flosser outlet;
an electronic control system operably coupled to the water supply system; and
a user interface operably coupled to the electronic control system, wherein the user interface comprises at least one motion sensor configured to receive a touchless user input;
wherein the electronic control system is configured to control at least one electronically controlled valve of the water supply system in response to the touchless user input.

2. The system of claim 1, wherein the water supply system comprises a hot-water intake and a cold-water intake configured to receive hot water and cold water, respectively, from the external water source.

3. The system of claim 2, wherein the at least one electronically controlled valve comprises a first electronically controlled ball valve configured to vary a ratio of hot water received through the hot-water intake and cold water received through the cold-water intake.

4. The system of claim 3, wherein the water supply system further comprises a water pump configured to drive water through the water supply system toward at least one of: the faucet outlet and the flosser outlet.

5. The system of claim 3, wherein the water supply system further comprises a pressure sensor configured to generate a pressure signal indicative of a pressure of water communicated through the water supply system.

6. The system of claim 5, wherein the water supply system further comprises a temperature sensor configured to generate a temperature signal indicative of a temperature of water communicated through the water supply system.

7. The system of claim 5, wherein the at least one motion sensor comprises a first pair of motion sensors positioned on a first lateral side of the faucet body and configured to receive touchless temperature-control inputs from a user.

8. The system of claim 7, wherein the at least one motion sensor further comprises a second pair of motion sensors positioned on a second lateral side of the faucet body opposite the first lateral side and configured to receive touchless pressure-control inputs from the user.

9. The system of claim 2, wherein the user interface further comprises a toggle switch configured to cause the water supply system to switch between a faucet-output mode in which water is expelled through the faucet outlet and a flosser-output mode in which water is expelled through the flosser outlet.

10. The system of claim 9, wherein the at least one electronically controlled valve comprises a second electronically controlled ball valve configured to divert water between a faucet conduit leading to the faucet outlet and a flosser conduit leading to the flosser outlet.

11. A method of operating a touchless faucet and flosser system, the method comprising:
receiving water from an external water source into a water supply system of the touchless faucet and flosser system;
receiving, by at least one motion sensor of a user interface, a touchless user input;
transmitting, from the at least one motion sensor to an electronic control system, a signal corresponding to the touchless user input;
controlling, by the electronic control system, at least one electronically controlled valve of the water supply system based at least in part on the signal; and
selectively expelling water through one of a faucet outlet of a faucet assembly and a flosser outlet of a flosser assembly wherein said flosser assembly is removably coupled to a faucet body of the faucet assembly.

12. The method of claim 11, further comprising mixing hot water received through a hot-water intake and cold water received through a cold-water intake by adjusting a ratio of hot water and cold water using at least one electronically controlled ball valve.

13. The method of claim 12, further comprising sensing a hand-position variation of a user using a first pair of motion sensors and adjusting a temperature of the water in response to the hand-position variation.

14. The method of claim 13, further comprising sensing a hand-position variation of a user using a second pair of motion sensors and adjusting a pressure of the water in response to the hand-position variation.

15. The method of claim 14, further comprising measuring, using a temperature sensor, a temperature of water communicated through the water supply system and transmitting a temperature signal to the electronic control system.

16. The method of claim 15, further comprising measuring, using a pressure sensor, a pressure of water communicated through the water supply system and transmitting a pressure signal to the electronic control system.

17. A sink-mounted faucet and flosser assembly comprising:
a sink base cabinet;
a basin supported by the sink base cabinet;
a faucet assembly positioned to expel water into the basin, the faucet assembly comprising a faucet body having a flosser recess;
a flosser assembly removably coupled to the faucet body within the flosser recess and configured to expel water into the basin;
a water supply system housed at least partially within the sink base cabinet and configured to communicate water to the faucet assembly and the flosser assembly; and
an electronic control system housed at least partially within the sink base cabinet and operably coupled to the water supply system;
wherein the electronic control system is configured to selectively control water flow from the water supply system to the faucet assembly or the flosser assembly.

18. The sink-mounted faucet and flosser assembly of claim 17, wherein the water supply system comprises a flosser conduit extending through the faucet body and configured to communicate water to the flosser assembly.

19. The sink-mounted faucet and flosser assembly of claim 18, wherein the flosser conduit comprises a weight configured to maintain a tensive force on the flosser conduit.

20. The sink-mounted faucet and flosser assembly of claim 18, wherein the electronic control system comprises:
a main controller;
a power input;
a power converter; and
a control generator;
the main controller being configured to transmit and receive signals for controlling operation of at least one of: a temperature sensor, a pressure sensor, a water pump, a user interface, and an electronically controlled valve.
